(19) United States
(12) Patent Application Publication
(10) Pub. No.: US 2022/0337508 A1
(43) Pub. Date: Oct. 20, 2022

(54) Path Verification Method and Related Device

(71) Applicant: Huawei Technologies Co., Ltd., Shenzhen (CN)

(72) Inventors: Haibo Wang, Beijing (CN); Shunwan Zhuang, Beijing (CN); Junli Jia, Shenzhen (CN); Hong Wu, Beijing (CN); Shuqiang Wang, Dongguan (CN)

(21) Appl. No.: 17/852,700

(22) Filed: Jun. 29, 2022

Related U.S. Application Data
(63) Continuation of application No. PCT/CN2020/119271, filed on Sep. 30, 2020.

(30) Foreign Application Priority Data
Dec. 31, 2019 (CN) 201911417073.X

(51) Int. Cl. H04L 45/02

(52) U.S. Cl. CPC H04L 45/04

(57) ABSTRACT

A path verification method includes a network device obtains path information of a packet forwarding path passing through a third autonomous system (AS), a second AS, and a first AS in sequence, and the third AS, the second AS, and the first AS are sequentially adjacent. The network device determines a first business relationship of a first AS pair and a second business relationship of a second AS pair, where the first AS pair includes the first AS and the second AS that are sequentially arranged, and the second AS pair includes the second AS and the third AS that are sequentially arranged. The network device determines, based on the first business relationship and the second business relationship, whether the packet forwarding path is valid.

### CROSS-REFERENCE TO RELATED APPLICATIONS

This application is a continuation of International Patent Application No. PCT/CN2020/119271, filed on Sep. 30, 2020, which claims priority to Chinese Patent Application No. 201911417073.X, filed on Dec. 31, 2019. The disclosures of the aforementioned applications are hereby incorporated by reference in their entireties.

### TECHNICAL FIELD

Embodiments of this application relate to the field of communication technologies, and in particular, to a path verification method and a related device.

### BACKGROUND

The Border Gateway Protocol (BGP) is an inter-autonomous system routing protocol running over the Transmission Control Protocol (TCP). As an external routing protocol, BGP mainly aims to ensure routing information communication between routers in different autonomous systems (ASes).

The BGP protocol was initially designed based on trustworthiness of neighbor information. Therefore, authentication information is not carried in BGP message exchange. Consequently, accidents such as route leakage and hijack often occur. To resolve such problems, a verification algorithm is usually added to the BGP protocol to determine whether advertisement of routing information is valid. An existing route origin authorization (ROA) algorithm can be used only to verify whether a source AS is tampered with. A BGP security (BGP Sec) algorithm is used to verify trustworthiness of routing information advertised by each AS, but has a forward compatibility vulnerability.

Therefore, how to simply and efficiently verify a BGP routing AS path and improve reliability of a verification algorithm is a problem to be resolved.

### SUMMARY

Embodiments of this disclosure provide a path verification method and a related device, to verify whether an advertisement path of a route is valid.

A first aspect of embodiments of this disclosure provides a path verification method, including:

When an AS advertises a route to another AS, a path of the route may be determined based on a packet forwarding path. A current network device obtains path information of the packet forwarding path, where the path information may be an ordered AS sequence that is sequentially a third AS, a second AS, and a first AS, and all the ASes in the ordered AS sequence are sequentially adjacent. Next, the network device divides the ordered AS sequence into AS pairs that are sequentially a first AS pair and a second AS pair, where the first AS pair includes the first AS and the second AS, the first AS and the second AS are sequentially arranged, the second AS pair includes the second AS and the third AS, and the second AS and the third AS are also sequentially arranged in the second AS pair. Then, the network device determines a business relationship of the first AS pair and a business relationship of the second AS pair, and further analyzes the business relationships of the two AS pairs, to determine whether the entire packet forwarding path is valid.

The network device not only needs to verify the sequentially arranged AS pairs, but also needs to determine, based on the business relationships of the two neighboring AS pairs, whether the routing path conforms to an advertisement rule. Therefore, according to this verification method, invalid route advertisement can be effectively verified, and a verification result is more trustworthy.

Based on the first aspect, this embodiment further provides a first implementation of the first aspect:

AS pairs may have three types of business relationships: a customer-to-provider (C2P) relationship, a provider-to-customer (P2C) relationship, and a peering relationship. For example, if the business relationship of the first AS pair is the C2P relationship, because the first AS and the second AS included in the first AS pair are sequentially arranged, an Internet service provider (ISP) corresponding to the first AS is a customer of an ISP corresponding to the second AS; if the business relationship of the first AS pair is the P2C relationship, an ISP corresponding to the first AS is a provider of an ISP corresponding to the second AS; or if the business relationship of the first AS pair is the peering relationship, an ISP corresponding to the first AS and an ISP corresponding to the second AS are peers to each other.

An AS pair may associate two ASes, and a business relationship of the AS pair may be used to represent a business relationship between the two ASes. This facilitates more concise description, and provides a prerequisite for subsequently determining validity of the entire path based on the business relationship of the AS pair.

Based on the first implementation of the first aspect, this embodiment further provides a second implementation of the first aspect:

The network device may verify the AS pair through comparison with a database, and obtain the business relationship of the AS pair. In an embodiment, the network device obtains two databases, namely, a first database and a second database, where the first database needs to include a first set, the first set needs to include at least one AS pair, and a second set also needs to include at least one AS pair. Then, the network device searches the databases for the to-be-verified first AS pair and the to-be-verified second AS pair. If the first set includes a to-be-verified AS pair, the network device determines that a business relationship of the AS pair is the C2P relationship. If the first set does not include a to-be-verified AS pair, but the second database includes a to-be-verified AS pair, the network device determines that a relationship of the AS pair is the P2C relationship.

The first database and the second database separately store AS pairs in different business relationships. In this way, when verifying a to-be-verified AS and determining the business relationship, the network device may directly verify the to-be-verified AS in the databases corresponding to the different business relationships without processing the to-be-verified AS pair, so that a verification process is simpler.

Based on the second implementation of the first aspect, this embodiment further provides a third implementation of the first aspect:

The first database further includes a second set in addition to the first set, and the second set also includes at least one AS pair whose business relationship is the peering relationship. When determining that the second set includes the to-be-verified first AS pair or the to-be-verified second AS pair, the network device determines that the business relationship of the AS pair is the peering relationship.

The AS pairs stored in the first database are classified into an AS pair in the C2P relationship and an AS pair in the peering relationship. In this way, the business relationship of the AS pair can be more accurately determined, so that the verification result is more trustworthy.

Based on any one of the first aspect to the third implementation of the first aspect, this embodiment further provides a fourth implementation of the first aspect:

When the AS pair is determined based on the path information of the packet forwarding path, a current AS further needs to be added to the packet forwarding path, that is, the third AS is the or initial AS that a packet passes through. In this way, whether a previous route received by the current AS is valid can be verified, so that the result of verifying whether the path is valid is more trustworthy.

Based on the fourth implementation of the first aspect, this embodiment further provides a fifth implementation of the first aspect:

When the packet forwarding path passes through a plurality of ASes in sequence, the network device determines whether the ordered AS identifier list corresponding to the packet forwarding path includes duplicated AS identifiers. If the ordered AS identifier list includes the duplicated AS identifiers, the duplicated AS identifiers are deduplicated, and only one of the same AS identifiers is retained, that is, it is ensured that a plurality of AS identifiers are mapped one-to-one to the plurality of ASes.

In some scenarios, when the route passes through one AS, an AS identifier is added to the ordered AS identifier list for a plurality of times. Such advertisement of routing information in the same AS does not affect whether route advertisement is valid. Therefore, the advertisement inside the AS does not need to be verified, and only route advertisement between two ASes needs to be verified. Verification performed after deduplication is simpler and more efficient.

Based on the third implementation of the first aspect or the fourth implementation of the first aspect, this embodiment further provides a sixth implementation of the first aspect:

When needing to determine the business relationship of the first AS pair and the business relationship of the second AS pair based on the first database and the second database, the network device may first download the first database from a database server, then generate the second database based on the downloaded first database, and further perform AS verification.

The second database may be established on a database server side, or may be established by the network device. In this way, a plurality of solutions may be provided, and flexibility is higher.

Based on the first aspect, this embodiment further provides a seventh implementation of the first aspect:

The network device may alternatively obtain only one database from a database server, but the database needs to include a mapping relationship between the first AS pair and a first business relationship and a mapping relationship between the second AS pair and a second business relationship. That is, AS pairs in the database have at least two types of business relationships, and each AS pair corresponds to a business relationship of the AS pair. In this way, when the database includes a to-be-verified AS pair, the network device directly determines, based on the mapping relationships, that the business relationship of the first AS pair is the first business relationship and that the business relationship of the second AS pair is the second business relationship.

Each AS in the foregoing database has a corresponding business relationship. In this way, a relationship between different ASes may be directly determined based on the business relationships included in the database, and comparison does not need to be performed based on a determined AS pair. A business relationship of an unregistered AS pair may also be deduced based on a business relationship of another AS pair, to more accurately learn of the business relationship of the AS pair.

Based on the seventh implementation the first aspect, this embodiment further provides an eighth implementation of the first aspect:

It may be understood that the network device may need to download the database from the database server to determine the business relationship of the AS pair based on the database.

A second aspect of embodiments of this application provides a database establishment method, including:

If needing to establish a database used to verify a routing path, a database server first obtains registration information of an ISP, and then constructs the database based on the registration information. If the registration information includes an AS identifier pair and a business relationship of the identifier pair, content in the database needs to be updated, and a mapping relationship between the AS identifier pair and the business relationship of the AS identifier pair needs to be established.

The database established by the database server not only includes AS identifier pairs, but each AS identifier pair further corresponds to a business relationship. A business relationship of an unregistered AS pair may be deduced based on the corresponding business relationship. In addition, the database may receive registration information of any ISP, so that a registration manner is more flexible.

Based on the second aspect, this embodiment further provides a first implementation of the second aspect:

Information about a business relationship of a first AS identifier pair may be a C2P relationship, a peering relationship, or a P2C relationship. If the business relationship of the first AS identifier pair is the C2P relationship, an Internet service provider ISP corresponding to a first AS is a customer of an ISP corresponding to a second AS. If the business relationship of the first AS identifier pair is the P2C relationship, an ISP corresponding to a first AS is a provider of an ISP corresponding to a second AS. If the business relationship of the first AS identifier pair is the peering relationship, an ISP corresponding to a first AS and an ISP corresponding to a second AS are peers to each other. In this way, a relationship between ASes can be clearly and directly obtained based on a business relationship of each AS pair.

Based on the first implementation of the second aspect, this embodiment further provides a second implementation of the second aspect:

After completing updating the database, the database server may further perform internal check in the database based on the business relationship. If the database further includes a second AS identifier pair, two AS identifiers included in the first AS identifier pair are the same as two AS identifiers included in the second AS identifier pair, but are in a different arrangement sequence from the two AS identifiers included in the second AS identifier pair, where the first AS identifier pair is sequentially a first AS identifier and a second AS identifier, and the second AS identifier pair is sequentially the second AS identifier and the first AS identifier. However, the database server finds that the business relationship of the first AS identifier pair is the same as a business relationship of a second AS pair. In this case, it may be determined that a mapping relationship between the first AS identifier pair and the business relationship of the first AS identifier pair and a mapping relationship between the second AS identifier pair and the business relationship of the second AS identifier pair are abnormal.

Two ASes form two AS pairs, where locations of the two ASes in the two pairs are different, and the two AS pairs should have corresponding business relationships. If a first AS pair is in the C2P relationship, a second AS pair should be in the P2C relationship. If the two AS pairs are both in the C2P relationship, it indicates that the registration information is incorrect and a mapping relationship between an AS pair and a business relationship is abnormal.

Based on the second aspect to the second implementation of the second aspect, this embodiment further provides a third implementation of the second aspect:

After completing updating the content in the database, the database server needs to send the mapping relationship between the AS identifier pair and the business relationship of the AS identifier pair to a network device. In this way, the network device can learn of a business relationship between ASes, and determine validity of the route advertisement path based on the business relationship between ASes.

A third aspect of embodiments of this application provides a database establishment method, including:

If registration information obtained by a database server includes only a first AS identifier pair, and the first AS identifier pair includes a first AS identifier and a second AS identifier that are sequentially arranged, the database server considers by default that the first AS identifier pair is in a business relationship, and establishes a first database based on the registration information, where the first database includes the first AS identifier pair. Then, the database server may establish a second database based on the first database, where the second database includes a second AS identifier pair, and the second AS identifier pair includes the second AS identifier and the first AS identifier that are sequentially arranged.

The database server establishes a P2C database based on a C2P database, or establishes a C2P database based on a P2C database. This may help directly verify a to-be-verified AS pair without processing the to-be-verified AS pair, so that a verification result is more convenient.

Based on the third aspect, this embodiment further provides a first implementation of the third aspect:

A business relationship of an AS identifier pair included in the first database is a C2P relationship and/or a peering relationship, and a business relationship of an AS identifier pair included in the second database is a P2C relationship and/or the peering relationship.

Based on the third aspect or the first implementation of the third aspect, this embodiment further provides a second implementation of the third aspect:

A database sends the first AS identifier pair to a network device based on the first database, and send the second AS identifier pair to the network device based on the second database. In this way, the network device may learn of a relationship between ASes based on different AS identifier pairs, and then determine validity of a route advertisement path based on the business relationship.

A fourth aspect of embodiments of this application provides a network device for path verification, where the network device includes: an obtaining unit configured to obtain path information of a packet forwarding path, where the packet forwarding path passes through a third AS, a second AS, and a first AS in sequence, and the third AS, the second AS, and the first AS are sequentially adjacent; a determining unit configured to determine a business relationship of a first AS pair and a business relationship of a second AS pair, where the first AS pair includes the first AS and the second AS that are sequentially arranged, and the second AS pair includes the second AS and the third AS that are sequentially arranged; and a judging unit configured to determine, based on the business relationship of the first AS pair and the business relationship of the second AS pair, whether the packet forwarding path is valid.

Based on the fourth aspect, this embodiment further provides a first implementation of the fourth aspect:

The business relationship includes a C2P relationship, a P2C relationship, and a peering relationship.

If the business relationship of the first AS pair is the C2P relationship, an ISP corresponding to the first AS is a customer of an ISP corresponding to the second AS.

If the business relationship of the first AS pair is the P2C relationship, an ISP corresponding to the first AS is a provider of an ISP corresponding to the second A.

If the business relationship of the first AS pair is the peering relationship, an TSP corresponding to the first AS and an ISP corresponding to the second AS are peers to each other.

Based on the first implementation of the fourth aspect, this embodiment further provides a second implementation of the fourth aspect:

The obtaining unit is configured to obtain databases, where the databases include a first database and a second database, the first database includes a first set, the first set includes at least one AS pair, and the second database includes at least one AS pair.

The determining unit is further configured to: when the first set includes the first AS pair, determine that the business relationship of the first AS pair is the C2P relationship; or when the first database does not include the first AS pair, but the second database includes the first AS pair, determine that the business relationship of the first AS pair is the P2C relationship.

Based on the second implementation of the fourth aspect, this embodiment further provides a third implementation of the fourth aspect:

The first database further includes a second set, and the second set includes at least one AS pair.

The determining unit is further configured to: when the second set includes the first AS pair, determine that the business relationship of the first AS pair is the peering relationship.

Based on the third implementation of the fourth aspect, this embodiment further provides a fourth implementation of the fourth aspect:

The network device further includes a generation unit, and the obtaining unit is further configured to download the first database from a database server.

The generation unit is configured to generate the second database based on the first database.

Based on the fourth aspect, this embodiment further provides a fifth implementation of the fourth aspect:

The obtaining unit is further configured to obtain a database, where the database includes a mapping relationship between the first AS pair and a first business relationship and a mapping relationship between the second AS pair and a second business relationship.

The determining unit is further configured to determine that the business relationship of the first AS pair is the first business relationship, and determine that the business relationship of the second AS pair is the second business relationship.

Based on the fifth implementation of the fourth aspect, this embodiment further provides a sixth implementation of the fourth aspect:

The obtaining unit is further configured to download the database from a database server.

A fifth aspect of embodiments of this application provides a database server, including an obtaining unit configured to obtain registration information, where the registration information includes a first AS identifier pair and a business relationship of the first AS identifier pair, and the first AS identifier pair includes a first AS identifier and a second AS identifier that are sequentially arranged; and an updating unit configured to update a database based on the registration information, where the updated database includes a mapping relationship between the first AS identifier pair and the business relationship of the first AS identifier pair.

Based on the fifth aspect, this embodiment further provides a first implementation of the fifth aspect:

Information about the business relationship of the first AS identifier pair is a C2P relationship, a peering relationship, or a P2C relationship.

If the business relationship of the first AS identifier pair is the C2P relationship, an ISP corresponding to a first AS is a customer of an ISP corresponding to a second AS.

lf the business relationship of the first AS identifier pair is the P2C relationship, an ISP corresponding to a first AS is a provider of an ISP corresponding to a second AS.

If the business relationship of the first AS identifier pair is the peering relationship, an ISP corresponding to a first AS and an ISP corresponding to a second AS are peers to each other.

Based on the first implementation of the fifth aspect, this embodiment further provides a second implementation of the fifth aspect:

The updated database further includes a mapping relationship between a second AS identifier pair and a business relationship of the second AS identifier pair, and the second AS identifier pair includes the second AS identifier and the first AS identifier that are sequentially arranged.

The server further includes a determining unit, where the determining unit is configured to: determine that the business relationship of the first AS identifier pair is the same as the business relationship of the second AS identifier pair; and determine that the mapping relationship between the first AS identifier pair and the business relationship of the first AS identifier pair is abnormal, and determine that the mapping relationship between the second AS identifier pair and the business relationship of the second AS identifier pair is abnormal.

Based on the fifth aspect to the second implementation of the fifth aspect, this embodiment further provides a third implementation of the fifth aspect:

The database server further includes a sending unit configured to send the mapping relationship between the first AS identifier pair and the business relationship of the first AS identifier pair to a network device based on the updated database.

A sixth aspect of embodiments of this application provides a database server, including: an obtaining unit configured to obtain registration information, where the registration information includes a first AS identifier pair, and the first AS identifier pair includes a first AS identifier and a second AS identifier that are sequentially arranged; and an establishment unit configured to: establish a first database based on the registration information, where the first database includes the first AS identifier pair; and establish a second database, where the second database includes a second AS identifier pair, and the second AS identifier pair includes the second AS identifier and the first AS identifier that are sequentially arranged.

Based on the sixth aspect, this embodiment further provides a first implementation of the sixth aspect:

A business relationship of an AS identifier pair included in the first database is a C2P relationship and/or a peering relationship, and a business relationship of an AS identifier pair included in the second database is a P2C relationship and/or the peering relationship.

Based on the sixth aspect or the first implementation of the sixth aspect, this embodiment further provides a second implementation of the sixth aspect:

The server further includes a sending unit configured to send the first AS identifier pair to a network device based on the first database, and send the second AS identifier pair to the network device based on the second database.

A seventh aspect of this application provides a network device, including at least one processor and a memory, where the memory stores computer-executable instructions capable of being run on the processor. When the computer-executable instructions are executed by the processor, the network device performs the method according to any one of the first aspect or the possible implementations of the first aspect.

An eighth aspect of this application provides a database server, including at least one processor and a memory, where the memory stores computer-executable instructions capable of being run on the processor. When the computer-executable instructions are executed by the processor, the database server performs the method according to any one of the second aspect or the possible implementations of the second aspect.

A ninth aspect of this application provides a database server, including at least one processor and a memory, where the memory stores computer-executable instructions capable of being run on the processor. When the computer-executable instructions are executed by the processor, the network device performs the method according to any one of the third aspect or the possible implementations of the third aspect.

A tenth aspect of this application provides a path verification system, including a network device, where the network device is the network device according to any one of the fourth aspect or the possible implementations of the fourth aspect.

An eleventh aspect of this application provides a database establishment system, including a database server, where the database server is the database server according to any one of the fifth aspect or the possible implementations of the fifth aspect.

A twelfth aspect of this application provides a database establishment system, including a database server, where the database server is the database server according to any one of the sixth aspect or the possible implementations of the sixth aspect.

A thirteenth aspect of embodiments of this application provides a computer storage medium. The computer storage medium is configured to store computer software instructions used by the foregoing network device or database server, and the computer software instructions include a program designed for the network device or the database server.

The network device may be the network device described in the fourth aspect.

The database server may be the database server described in the fifth aspect or the sixth aspect.

A fourteenth aspect of this application provides a chip or a chip system. The chip or the chip system includes at least one processor and a communication interface. The communication interface and the at least one processor are interconnected through a line. The at least one processor is configured to run a computer program or instructions, to perform the path verification method according to any one of the first aspect or the possible implementations of the first aspect.

The communication interface in the chip may be an input/output interface, a pin, a circuit, or the like.

In a possible implementation, the chip or the chip system described in this application further includes at least one memory, and the at least one memory stores the instructions. The memory may be a storage unit inside the chip, for example, may be a register or a cache; or may be a storage unit (for example, a read-only memory (ROM) or a random-access (RAM) memory) of the chip.

A fifteenth aspect of this application provides a chip or a chip system. The chip or the chip system includes at least one processor and a communication interface. The communication interface and the at least one processor are interconnected through a line. The at least one processor is configured to run a computer program or instructions, to perform the database establishment method according to any one of the second aspect or the possible implementations of the second aspect.

The communication interface in the chip may be an input/output interface, a pin, a circuit, or the like.

In a possible implementation, the chip or the chip system described in this application further includes at least one memory, and the at least one memory stores the instructions. The memory may be a storage unit inside the chip, for example, may be a register or a cache; or may be a storage unit (for example, a ROM or a RAM) of the chip.

A sixteenth aspect of this application provides a chip or a chip system. The chip or the chip system includes at least one processor and a communication interface. The communication interface and the at least one processor are interconnected through a line. The at least one processor is configured to run a computer program or instructions, to perform the database establishment method according to any one of the third aspect or the possible implementations of the third aspect.

The communication interface in the chip may be an input/output interface, a pin, a circuit, or the like.

In a possible implementation, the chip or the chip system described in this application further includes at least one memory, and the at least one memory stores the instructions. The memory may be a storage unit inside the chip, for example, may be a register or a cache; or may be a storage unit (for example, a ROM or a RAM) of the chip.

A seventeenth aspect of embodiments of this application provides a computer program product, where the computer program product includes computer software instructions, and the computer software instructions may be loaded by a processor to implement a procedure in the path verification method according to any possible implementation of the first aspect or a procedure in the database establishment method according to any possible implementation of the second aspect and the third aspect.

It can be learned from the foregoing technical solutions that embodiments of this application have the following advantages:

According to the present disclosure, the network device first determines AS pairs based on the obtained path information of the packet forwarding path, then verifies each AS pair to determine a business relationship of the AS pair, and further determines, based on business relationships of neighboring AS pairs, whether the path is valid. In this way, a leakage status of P2P routing information can be verified more accurately, so that the verification result is more trustworthy.

### BRIEF DESCRIPTION OF DRAWINGS

FIG. 1 is a topology diagram of a business relationship between ISPs according to an embodiment of the present disclosure;

FIG. 2 is a diagram of a network structure in an AS according to an embodiment of the present disclosure;

FIG. 3 is a schematic flowchart of a path verification method according to an embodiment of the present disclosure;

FIG. 4 is a schematic flowchart of another path verification method according to an embodiment of the present disclosure;

FIG. 5 is a schematic diagram of a structure of a network device according to an embodiment of the present disclosure;

FIG. 6 is a schematic diagram of a structure of a database server according to an embodiment of the present disclosure;

FIG. 7 is a schematic diagram of a structure of a database server according to an embodiment of the present disclosure;

FIG. 8 is a schematic diagram of a structure of another network device according to an embodiment of the present disclosure;

FIG. 9 is a schematic diagram of a structure of another database server according to an embodiment of the present disclosure; and

FIG. 10 is a schematic diagram of a structure of another database server according to an embodiment of the present disclosure.

### DESCRIPTION OF EMBODIMENTS

Embodiments of the present disclosure provide a path verification method and a related device, to verify whether advertisement of routing information is valid.

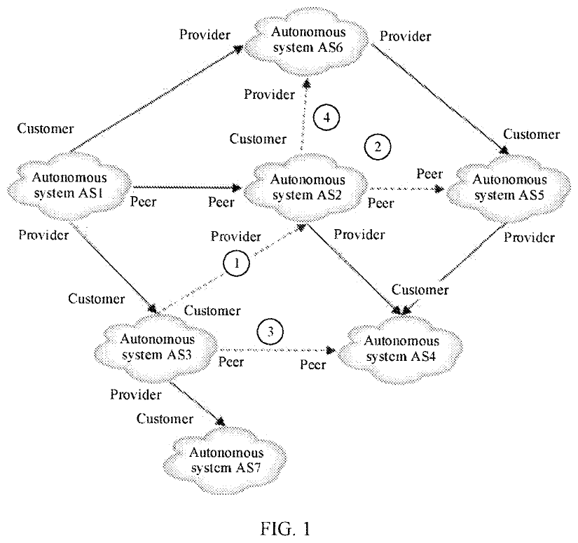

FIG. 1 is a topology diagram of a business relationship between ISPs according to the present disclosure. As shown in FIG. 1, each ISP corresponds to one AS, the ASes are distinguished by using AS numbers, and a business relationship in each Internet is configured in advance.

For the Internet, generally, ISPs are mainly classified into a provider, a customer, and a peer. A business relationship between two ISPs is generally a P2C relationship, a C2P relationship, and a peering relationship. For example, in FIG. 1, a relationship between AS1 and AS3 is the P2C relationship, that is, AS3 is a customer of AS1; a relationship between AS1 and AS6 is the C2P relationship, that is, AS6 is a provider of AS1; a relationship between AS1 and AS2 is the peering relationship, that is, AS1 and AS2 are two peers.

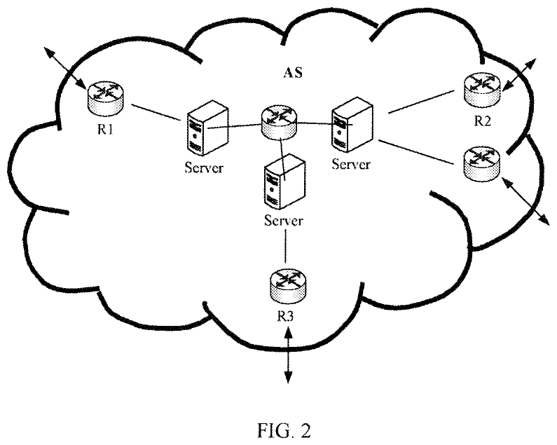

FIG. 2 uses an example to describe a network architecture in any AS in the present disclosure. As shown in FIG. 2, each ISP corresponds to one AS, and the AS includes a plurality of devices such as a plurality of routing devices and a plurality of servers. The plurality of servers exchange data through the routing devices. For example, R1, R2, and R3 are BGP border routers, are connected to a border router of a neighboring AS, and execute a BGP routing protocol to complete data exchange between different ASes.

In a routing information advertisement process, there may be an upstream advertisement mode and a downstream advertisement mode. Specifically, in the upstream advertisement mode, a customer advertises routing information to a provider; in the downstream advertisement mode, a provider advertises routing information to a customer. On a routing path, a route advertisement rule is that a routing device is not allowed to advertise, to a provider neighbor or a peering neighbor of the routing device, routing information learned from another provider neighbor of the routing device, and is not allowed to advertise, to a provider neighbor or a peering neighbor of the routing device, routing information learned from another peering neighbor of the routing device.

For example, in the foregoing topology diagram, AS1 is a provider neighbor of AS3, AS2 is another provider neighbor of AS3, AS7 is a customer neighbor of AS3, and AS4 is a peering neighbor of AS3. After AS1 advertises routing information to AS3, AS3 may continue to advertise the learned routing information to AS7, but is not allowed to advertise the learned routing information to AS2 or AS4. That is, on a route advertisement path, there may be three cases for the advertisement modes: 1. Route advertisement is performed in the upstream advertisement mode. 2. Route advertisement is performed in the downstream advertisement mode. 3. Route advertisement is performed first in the upstream advertisement mode and then in the downstream advertisement mode, where in this case, the advertisement mode can be changed only once.

If a routing device advertises, to a provider neighbor or a peering neighbor, routing information learned from another provider neighbor or another peering neighbor of the routing device, the routing information leaks, and accurate verification needs to be performed by using a verification algorithm in these several cases to obtain a reliable verification result.

A routing AS path (AS-PATH) attribute is a well-known mandatory attribute of BGP, and means recording a route advertisement path by using ordered AS numbers. When initiating a route, a BGP speaker adds an AS number of the BGP speaker to an AS-PATH. That is, each time the route passes through an AS, an AS number of the AS is added to the AS-PATH. The AS-PATH may be used to describe all ASes that the route passes through, and more added AS numbers indicate more ASes that the route passes through. For example, in the foregoing topology diagram, AS1 advertises a route, and the route is transmitted to AS4 through AS6 and AS5 in sequence. In this case, an AS-PATH that is of the route and that is received by AS4 is AS5 AS6 AS1.

An existing manner of storing a business relationship between ISPs is as follows: An ISP whose business role is a customer or a peer in two ASes performs registration. For example, in the foregoing topology diagram, for AS1, AS1 is a customer neighbor of AS6, and is a peering neighbor of AS2. Therefore, AS1 needs to report AS6 and AS2 to a database server, and the database server generates two AS pairs, namely, (AS1, AS2) and (AS1, AS6). (AS1, AS6) is used to indicate that AS1 and AS6 are in the C2P relationship, in other words, AS1 is a customer neighbor of AS6; (AS1, AS2) is used to indicate that AS1 and AS2 are in the peering relationship, in other words, AS1 is a peering neighbor of AS2. However, AS1 is a provider neighbor of AS3. In this case, AS3 instead of AS1 needs to register a relationship between AS3 and AS1, so that an AS pair (AS3, AS1) is generated. This ensures that all AS pairs in a database are in the C2P relationship and the peering relationship, and two AS numbers in each AS pair are arranged in sequence strictly. It may be understood that the database may be referred to as a C2P database.

For example, if all customers in the foregoing topology diagram 1 perform registration, content in the C2P database is shown as follows:

(AS1, AS2), (AS1, AS6);

(AS2, AS1), (AS2, AS5), (AS2, AS6);

(AS3, AS1), (AS3, AS2), (AS3, AS4);

(AS4, AS2), (AS4, AS3), (AS4, AS5);

(AS5, AS2), (AS5, AS6);

(AS6, 0);

(AS7, AS3).

Then, verification may be performed based on the database, and a specific verification result is as follows:

When a routing device receives a packet related to route advertisement, the routing device first obtains an AS-PATH of a route; groups ordered AS numbers in the AS-PATH, where two sequentially adjacent AS numbers form an AS pair; and then compares, with an AS pair in the database, each AS pair obtained through grouping. For a single AS pair, whether a leftmost AS in the AS pair has performed registration is first verified. If the leftmost AS has not performed registration, a verification result is returned as unknown. If the leftmost AS pair has performed registration, but there is no to-be-verified AS pair in AS pairs in the database that correspond to the leftmost AS, a verification result is returned as invalid. If a to-be-verified AS pair is exactly matched, a result is returned as valid. Generally, the verification result as unknown may be considered as valid.

Verification of the entire path is classified into the following several cases. If the 1^{st} AS pair in the AS-PATH is successfully verified in the C2P database, that is, two adjacent ASes in the 1^{st} AS pair are in the C2P relationship, subsequent AS pairs that are sequentially arranged need to be verified in sequence. If all the AS pairs are successfully verified, it indicates that the path for the route advertisement is valid and the route advertisement is performed in the upstream advertisement mode. If the 0 AS pair in the AS-PATH is successfully verified in the C2P database, once a verification failure result occurs during sequential verification of subsequent AS pairs, locations of AS numbers in all subsequent to-be-verified AS pairs need to be reversed, and reversed AS pairs are verified one by one. If all the reversed AS pairs are successfully verified, it indicates that the path for the route advertisement is valid and the route advertisement is performed first in the upstream advertisement mode and then in the downstream advertisement mode. Once a verification failure result occurs on the reversed AS pairs, the entire path is invalid.

If the 1^{st} AS pair in the AS-PATH fails to be verified in the C2P database, locations of AS numbers in all subsequent to-be-verified AS pairs need to be reversed, and then all reversed AS pairs are verified one by one. Once a reversed AS pair fails to be verified, the entire path is invalid. If all the reversed AS pairs are successfully verified, it indicates that the path for the route advertisement is valid and the route advertisement is performed in the downstream advertisement mode.

For example, a verification process may be as follows:

It is assumed that when AS7 advertises a route to AS2, an AS-PATH that is of the route and that is received by AS2 is AS4 AS3 AS7.

The AS-PATH is first divided into AS pairs, namely, (AS7, AS3) and (AS3, AS4), and then the two AS pairs are verified separately. Because (AS7, AS3) exists in the foregoing C2P database, a verification result of (AS7, AS3) is valid; similarly, a verification result of (AS3, AS4) is also valid. According to the foregoing verification rule, a verification result of the path is that the path is valid. However, actually, for AS4, AS4 advertises, to the provider neighbor AS2 of AS4, routing information learned from the peering neighbor AS3 of AS4. This violates the advertisement principle, and the path should be invalid. Therefore, according to the foregoing algorithm, the verification result is untrustworthy.

It is assumed that when AS1 advertises a route to AS2, an AS-PATH that is of the route and that is received by AS2 is AS3 AS1.

Similarly, the AS-PATH is divided into (AS1, AS3), and then verification is performed based on the foregoing C2P database. In the database, the AS pairs registered by AS3 do not include (AS1, AS3). Therefore, a verification result of (AS1, AS3) is invalid, and the entire path is also invalid. Actually, on the path, AS3 provides, to the provider neighbor AS2 of AS3, routing information learned from another provider neighbor AS1. Such route advertisement is invalid, and therefore a verification result is trustworthy.

It is assumed that when AS1 advertises a route to AS6, an AS-PATH that is of the route and that is received by AS6 is AS2 AS1.

Similarly, the AS-PATH is divided into (AS1, AS2), and then verification is performed based on the foregoing C2P database. In the database, the AS pairs registered by AS1 include (AS1, AS2). Therefore, a verification result of (AS1, AS2) is valid, and the entire path is also valid. Actually, on the path, AS2 provides, to the provider neighbor AS6 of AS2, routing information learned from the peering neighbor AS1. Such route advertisement is invalid, and therefore a verification result is untrustworthy.

It is assumed that when AS3advertises a route to AS5, an AS-PATH that is of the route and that is received by AS5 is AS2 AS6 AS1 AS3.

Similarly, the AS-PATH is divided into (AS3, AS1), (AS1, AS6), and (AS6, AS2). Based on the foregoing C2P database, a verification result of (AS3, AS1) is valid, a verification result of (AS1, AS6) is valid, and a verification result of (AS6, AS2) is invalid. Therefore, the entire path is invalid. Actually, on the path, AS2 provides, to the peering neighbor AS5 of AS2, routing information learned from the provider neighbor AS6. Such route advertisement is invalid, and therefore a verification result is trustworthy.

It is assumed that when AS3 advertises a route to AS4, an AS-PATH that is of the route and that is received by AS4 is AS5 AS2 AS6 AS1 AS3.

Similarly, the AS-PATH is divided into (AS3, AS1), (AS1, AS6), (AS6, AS2), and (AS2, AS5). Based on the foregoing C2P database, a verification result of (AS3, AS1) is valid, a verification result of (AS1, AS6) is valid, and a verification result of (AS6, AS2) is invalid. After (AS6, AS2) is verified to be invalid, (AS2, AS5) needs to be reversed to (AS5, AS2), and then (AS5, AS2) is verified. A verification result is valid. Therefore, the entire path is valid. Actually, on the path, AS2 provides, to the peering neighbor AS5of AS2, routing information learned from the provider neighbor AS6. Such route advertisement is invalid, and therefore a verification result is untrustworthy.

It is assumed that when AS1 advertises a route to AS4, an AS-PATH that is of the route and that is received by AS4 is AS2 AS3 AS1.

Similarly, the AS-PATH is divided into (AS1, AS3) and (AS3, AS2). Based on the foregoing C2P database, a verification result of (AS1, AS3) is invalid. After (AS1, AS3) is verified to be invalid, (AS1, AS3) needs to be reversed to (AS3, AS1), and then (AS3, AS1) is verified. A verification result is invalid. Therefore, the entire path is invalid. Actually, on the path, AS3 provides, to the provider neighbor AS2 of AS3, routing information learned from the provider neighbor AS1. Such route advertisement is invalid, and therefore a verification result is trustworthy.

For the foregoing cases in which the verification result is untrustworthy, the present disclosure provides the following embodiments. The following describes technical solutions in the present disclosure in detail with reference to accompanying drawings. It is clear that the described embodiments are merely some rather than all of embodiments of the present disclosure.

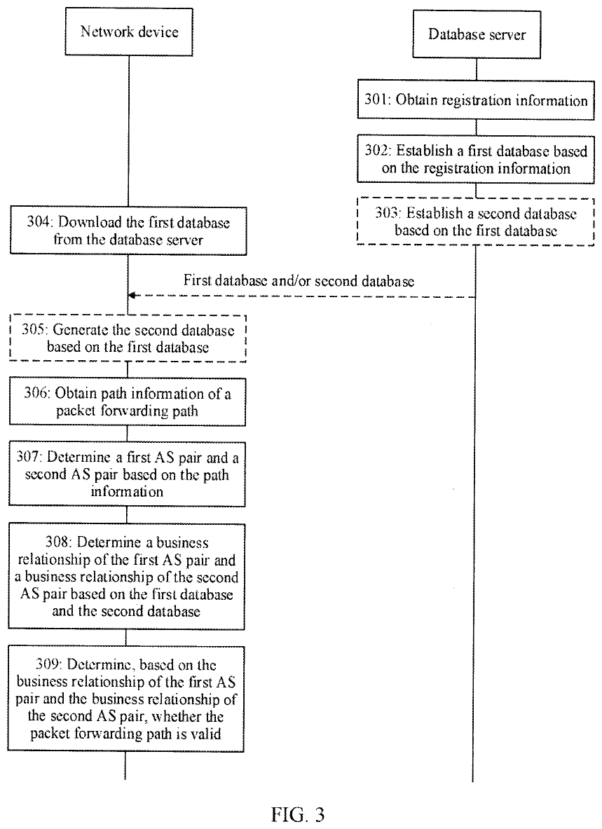

FIG. 3 is a schematic flowchart of a path verification method according to an t embodiment of the present disclosure. As shown in FIG. 3, the method includes the following steps.

301: A database server obtains registration information.

An ISP may send a registration request to an Internet information center. After the registration request is reviewed, ASes corresponding to different ISPs and a business relationship between the ISPs are determined based on the registration information reported by the ISP, and then the business relationship between the ISPs is stored. Specifically, the registration information may be sent to the database server, and the database server establishes a database of the business relationship between the ISPs. A manner of the registration request may be application by mail, submission of a registration table, or the like, and a specific manner is not limited.

A business relationship between different ASes may include: a C2P relationship, a P2C relationship, and a peering relationship. The registration information may be an AS identifier pair, and the AS identifier pair includes a first AS identifier and a second AS identifier that are sequentially arranged, where the first AS identifier may be an AS number corresponding to an AS uploading the registration information, and the second identifier is an AS number corresponding to a neighboring AS of the AS.

It may be understood that two ASes may form an AS pair. For example, if AS numbers corresponding to the two ASes are respectively AS1 and AS2, two AS pairs, namely, (AS1, AS2) and (AS2, AS1), may be formed in different arrangement sequences.

If a business relationship of the AS pair (AS1, AS2) is the C2P relationship, an ISP corresponding to AS1 is a customer of an ISP corresponding to AS2. In this case, a business relationship of (AS2, AS1) is the P2C relationship.

If a business relationship of the AS pair (AS1, AS2) is the P2C relationship, an ISP corresponding to AS1 is a provider of an ISP corresponding to AS2. In this case, a business relationship of (AS2, AS1) is the P2C relationship.

If a business relationship of the AS pair (AS1, AS2) is the peering relationship, an ISP corresponding to AS1 and an ISP corresponding to AS2 are peers to each other. In this case, a business relationship of (AS2, AS1) is also the peering relationship. Therefore, the ISP needs to upload different AS pairs to the database server according to different registration rules.

In this embodiment, an ISP whose business role is a customer may perform registration, and the ISP only needs to provide AS numbers corresponding to all provider neighbors and peering neighbors of the ISP to the database server. For example, in the topology diagram shown in FIG. 1, for AS1, a provider neighbor of AS1 includes AS6, and a peering neighbor of AS1 includes AS2. In this case, AS1 only needs to provide AS6 and AS2 to the database server during registration.

302: The database server establishes a first database based on the registration information.

After receiving the registration information, the database server establishes the first database based on the registration information. If an AS whose business role is a customer performs registration, the first database established by a network device is a C2P database, that is, a business relationship of each AS pair in the database is the C2P relationship or the peering relationship. For example, the provider neighbor of AS1 includes AS6, and the peering neighbor of AS1 includes AS2. In this case, the database server establishes two AS pairs, namely, (AS1, AS6) and (AS1, AS2), based on the registration information, where relationships of the two AS pairs are the C2P relationship or the peering relationship.

Because the business relationships of the AS pairs in the first database include both the C2P relationship and the peering relationship, to distinguish the business relationships in more detail, one solution is classifying the AS pairs in the first database. The first database may include a first set and a second set, each of the first set and the second set includes at least one AS pair, a business relationship of the AS pair in the first set is the C2P relationship, and a business relationship of the AS pair in the second set is the peering relationship.

It may be understood that, because whether a reported AS identifier represents a provider neighbor or a peering neighbor is not identified in the first database, the AS pair whose business relationship is the peering relationship in the first database needs to be determined during division into the first set and the second set. In an optional implementation, the first database may be searched for two target AS pairs that include same AS identifiers, where locations of the AS identifiers in the target AS pairs are different, and then it is determined that two ASes in the target AS pairs are in the peering relationship. It may be understood that, assuming that the AS pair (AS1, AS2) is generated based on registration information of AS1, and the AS pair (AS2, AS1) is generated based on registration information of AS2, it indicates that AS1 and AS2 are peers to each other and are in the peering relationship. In this way, the AS pair corresponding to AS1 and AS2 needs to be established in the second set. Optionally, a peering relationship label may be marked for the AS pair in the second set, to distinguish the AS pair in the second set from the AS pair in the first set.

303: The database server establishes a second database based on the first database.

After the first database is established, a P2C database may be established based on the first database. Specifically, locations of AS identifiers in the AS pair in the first set of the first database may be reversed, and a reversed AS pair is stored in the P2C database. For example, the AS pair (AS1, AS2) exists in the C2P database, that is, AS1 is a customer of AS2. Then, a reversed AS pair (AS2, AS1) corresponding to the AS pair is determined based on the AS pair, and is stored in the P2C database, that is, AS2 is a provider of AS1.

It may be understood that the P2C database is in a one-to-one correspondence with the C2P database, and a business relationship between ASes included in the P2C database does not change. Optionally, the P2C database may also include the AS pair in the peering relationship. This is not specifically limited. When the network device performs path verification, if a downstream advertisement mode is used on the path, a to-be-verified AS pair does not need to be reversed during verification of an AS pair corresponding to the path, but may be directly verified by using the P2C database, so that a verification process is simpler and more convenient.

It may be understood that an AS whose business role is a provider may alternatively perform registration. A P2C database is established based on the registration information, and then a C2P database is established based on the P2C database. This is not specifically limited. In addition, the second database may or may not be established by the database server, that is, step 303 may be performed or may not be performed. This is not specifically limited.

304: The network device downloads the first database from the database server.

When the network device performs verification by using the database, the network device needs to first download the first database generated by the database server based on the registration information. If the database server has generated the second database based on the first database, the network device may download the first database and the second database.

It may be understood that, downloading the first database by the network device is a process in which the database server sends content in the database to the network device. The database server needs to send a first AS identifier pair to the network device based on the first database, and send a second AS identifier pair to the network device based on the second database, so that the network device performs path verification based on different identifier pairs.

305: The network device generates the second database based on the first database.

When the network device downloads only the first database, the network device may generate the second database based on the first database. For a specific manner, refer to the method for generating the second database by the database server in step 203.

306: The network device obtains path information of a packet forwarding path.

When an AS advertises a route to another AS, a path of the route may be determined based on the packet forwarding path. Specifically, the network device may obtain an AS-PATH corresponding to the route, where AS numbers sequentially arranged in the AS-PATH are ASes that the route sequentially passes through, that is, the network device determines that the packet forwarding path sequentially passes through a third AS, a second AS, and a first AS. It may be understood that the received AS-PATH represents the ASes that the route sequentially passed through previously. Because route leakage also occurs on the current AS, one solution is adding a current AS number to the AS-PATH, that is, the third AS is the 1^{st} AS that the packet forwarding path passes through.

After the packet forwarding path is determined based on the AS-PATH and the current AS number, an ordered AS number list needs to be deduplicated. That is, in the ordered AS number list, deletion is performed to retain only one of same AS numbers. In this way, it can be ensured that the path information of the packet forwarding path is an ordered AS identifier list, and the ordered AS identifier list includes a plurality of sequentially arranged AS identifiers, where the plurality of AS identifiers are mapped one-to-one to a plurality of ASes.

For example, if AS2 advertises a route to AS7, and an AS-PATH received by AS7 is AS4 AS5 AS1 AS6 AS3, path information that is of the route and that is determined by AS7 is AS7 AS4 AS5 AS1 AS6 AS3.

307: The network device determines a first AS pair and a second AS pair based on the path information.

After determining the path information, the network device needs to group the path information to determine the AS pairs. For example, for the path information in step 305, AS pairs may be determined as (AS3, AS6), (AS6, AS1), (AS1, AS5), (AS5, AS4), and (AS4, AS7).

It may be understood that there is no chronological order between step 305 and step 306 and between step 303 and step 304. The network device may receive the path information of the packet forwarding path after downloading or generating the database in advance, or may download or generate the database after receiving the path information of the packet forwarding path. This is not specifically limited.

308: The network device determines a business relationship of the first AS pair and a business relationship of the second AS pair based on the first database and the second database.

After the AS pairs are determined, the business relationships of the AS pairs need to be sequentially determined. Specifically, the AS pairs are compared one by one with the first database and the second database. When the first set of the first database includes a to-be-verified AS pair, the network device determines that a business relationship of the AS pair is the C2P relationship. When the first database does not include a to-be-verified AS pair, but the second database includes a to-be-verified AS pair, the network device determines that a business relationship of the AS pair is the P2C relationship. Optionally, if the second set of the first database includes a to-be-verified AS pair, the network device determines that a business relationship of the AS pair is the peering relationship.

309: The network device determines, based on the business relationship of the first AS pair and the business relationship of the second AS pair, whether the packet forwarding path is valid.

After completing verification of the AS pairs one by one, the network device may obtain the business relationship of each AS pair, and then needs to determine, based on business relationships of neighboring AS pairs, whether the path is valid. For example, in the path information shown in step 306, if a business relationship of (AS5, AS4) is the peering relationship, and a business relationship of (AS4, AS7) is the C2P relationship, it is determined that AS4 advertises, to the provider neighbor AS7 of AS4, a route learned from the peering neighbor AS5 of AS4. This violates a route advertisement principle, and it is determined that the path is invalid.

The following analyzes the cases in which the verification result is untrustworthy in the method in FIG. 1.

First, the database server determines the peering relationship in the C2P database in FIG. 1, and marks the peering relationship, to obtain the following content in a new C2P database:

(AS1, AS2)-peering, (AS1, AS6);

(AS2, AS1)-peering, (AS2, AS5)-peering, (AS2, AS6);

(AS3, AS1), (AS3, AS2), (AS3, AS4)-peering;

(AS4, AS2), (AS4, AS3)-peering, (AS4, AS5);

(AS5, AS2)-peering, (AS5, AS6);

AS6, 0);

(AS7, AS3).

Then, a P2C database is generated based on the C2P database, where content in the P2C database is:

(AS1, AS3)

(AS2, AS3), (AS2, AS4);

(AS3, AS7);

(AS5, AS4);

(AS6, AS1), (AS6, AS2), (AS6, AS5).

It is assumed that when AS7 advertises a route to AS2, an AS-PATH that is of the route and that is received by AS2 is AS4 AS3 AS7.

First, the AS-PATH is divided into AS pairs, namely, (AS7, AS3), (AS3, AS4), and (AS4, AS2). Then, the three AS pairs are verified separately. The foregoing C2P database includes (AS7, AS3). In this case, a verification result of (AS7, AS3) is valid, and a business relationship of (AS7, AS3) is the C2P relationship. Similarly, a verification result of (AS3, AS4) is also valid, and a business relationship of (AS3, AS4) is the peering relationship; a verification result of (AS4, AS2) is valid, and a business relationship of (AS4, AS2) is the C2P relationship. Then, based on business relationships of two neighboring AS pairs, in (AS3, AS4) and (AS4, AS2), the business relationship of (AS3, AS4) is the peering relationship, and the business relationship of (AS4, AS2) is the C2P relationship. AS4 advertises, to the provider neighbor AS2 of AS4, a route learned from the peering neighbor AS3. This violates the advertisement principle. In this case, it is determined that a verification result is invalid, and the verification result is trustworthy.

It is assumed that when AS1 advertises a route to AS6, an AS-PATH that is of the route and that is received by AS6 is AS2 AS1.

Similarly, the AS-PATH is divided into (AS1, AS2) and (AS2, AS6). Then, verification is performed based on the foregoing C2P database. The AS pairs registered by AS1 in the database include (AS1, AS2). A verification result of (AS1, AS2) is valid, and a business relationship of (AS1, AS2) is the peering relationship; a verification result of (AS2, AS6) is valid, and a business relationship of (AS2, AS6) is the peering relationship. Then, it is determined based on the business relationships that advertising, by AS2 to the provider neighbor AS6 of AS2, a route learned from the peering neighbor AS1 violates the advertisement principle. In this case, it is determined that a verification result is invalid, and the verification result is trustworthy.

It is assumed that when AS3 advertises a route to AS4, an AS-PATH that is of the route and that is received by AS4 is AS5 AS2 AS6 AS1 AS3. Similarly, the AS-PATH is divided into (AS3, AS1), (AS1, AS6), (AS6, AS2), (AS2, AS5), and (AS5, AS4). Based on the foregoing C2P database, a verification result of (AS3, AS1) is valid, a verification result of (AS1, AS6) is valid, business relationships of (AS3, AS1) and (AS1, AS6) are both the C2P relationship, and a verification result of (AS6, AS2) is invalid.

After (AS6, AS2) is verified to be invalid, verification may be directly performed based on the P2C database. (AS6, AS2) is valid and a business relationship of (AS6, AS2) is the P2C relationship; (AS2, AS5) is valid and a business relationship of (AS2, AS5) is the peering relationship; (AS5, AS4) is valid and a business relationship of (AS5, AS4) is the P2C relationship. Then, based on business relationships of neighboring AS pairs, AS2 provides, to the peering neighbor AS5 of AS2, routing information learned from the provider neighbor AS6, and the routing path is determined to be invalid. In this case, a verification result is trustworthy.

In this embodiment, the network device not only needs to verify the single AS pair corresponding to the path information, but also needs to determine, based on the business relationships of the neighboring AS pairs, whether the path is valid. In this way, a leakage status of the P2P routing information can be verified more accurately, so that the verification result is more trustworthy.

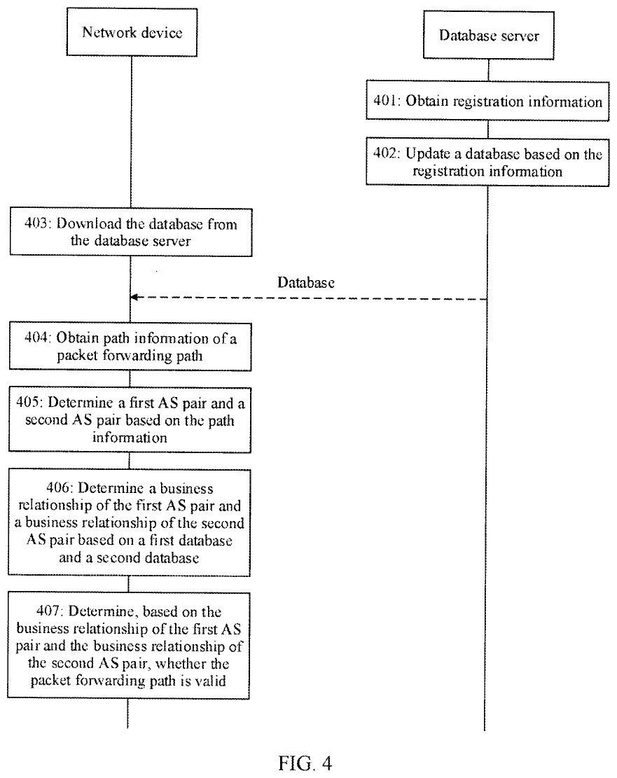

FIG. 4 is a schematic flowchart of another path verification method according to an embodiment of the present disclosure. As shown in FIG. 4, the method includes the following steps.

401: A database server obtains registration information.

In this embodiment, the registration information needs to include one AS identifier pair and a business relationship of the AS identifier pair, where the AS identifier pair includes a first AS identifier and a second AS identifier that are sequentially arranged.

In this embodiment, when an ISP registers a business relationship with the database server, any AS instead of a customer only may perform registration, and may report a provider neighbor, a peering neighbor, or a customer neighbor of the AS. For example, the first. AS identifier may be an AS number corresponding to the AS, and the second AS identifier may be an AS number of the provider neighbor corresponding to the AS, an AS number of the customer neighbor corresponding to the AS, or an AS number of the peering neighbor corresponding to the AS. Because an AS pair includes only AS identifiers, a corresponding business relationship between two ASes further needs to be reported.

For example, in the topology diagram shown in FIG. 1, when AS1 uploads registration information to the database server, the registration information may be (AS1, AS6), C2P; (AS1, AS2), peering; and (AS1, AS2), P2C. It may be understood that (AS1, AS6), C2P means that AS1 is a customer neighbor of AS6; (AS1, AS2), peering means that AS1is a peering neighbor of AS2; (AS1, AS2), P2C means that AS1 is a provider neighbor of AS2.

402: The database server updates a database based on the registration information.

When obtaining the registration information, the database server updates content in the database based on the registration information, to establish a corresponding AS pair and establish a mapping relationship between the AS pair and a business relationship of the AS identifier pair. In this way, a business relationship between corresponding ASes may be learned of based on each AS pair.

It may be understood that, because the business relationship of the AS pair in the database is definite, some business relationships between unregistered ASes may be learned of based on the stored AS pair. For example, the database includes (AS1, AS6), C2P. In this case, it may be learned that AS1 is a customer neighbor of AS6. When AS6 does not perform registration with the database server, in a verification process, it may still be deduced that a business relationship of the to-be-verified AS pair (AS1, AS6) is the P2C relationship.

In the database, if there is a mapping relationship between an AS pair and a business relationship, data in the database may be further checked. For example, when the database includes a first AS identifier pair in which an arrangement sequence is a first AS number and a second AS number, and further includes a second AS identifier pair in which an arrangement sequence is the second AS number and the first AS number, and the database server determines that a business relationship of the first AS identifier pair is the same as a business relationship of the second AS identifier pair, it is determined that a mapping relationship between the first AS identifier pair and the business relationship of the first AS identifier pair is abnormal and a mapping relationship between the second AS identifier pair and the business relationship of the second AS identifier pair is abnormal.

For example, if the database includes (AS1, AS6), C2P, it may be learned that AS1 is a customer neighbor of AS6, but the database further includes (AS6, AS1), C2P, that is, AS6 is a customer neighbor of AS1. These conflict with each other, and it indicates that mapping of a business relationship between the two ASes is incorrect.

403: A network device downloads the database from the database server.

When the database server completes updating the database, the network device needs to download the database, and performs path verification based on the AS pair in the database.

It may be understood that, downloading the database by the network device is a process in which the database server sends the content in the database to the network device. The database server sends the mapping relationship between the first AS identifier pair and the business relationship of the first AS identifier pair to the network device based on the updated database, so that the network device performs path verification based on the AS identifier pair in the database.

404: The network device obtains path information of a packet forwarding path.

Step 404 is similar to step 306 in the embodiment shown in FIG. 3, and

405: The network device determines a first AS pair and a second AS pair based on the path information.

Step 405 is similar to step 307 in the embodiment shown in FIG. 3, and

It may be understood that there is no chronological order between step 403 and each of step 405 and step 404. The network device may receive the path information of the packet forwarding path after downloading the database in advance, or may download the database after receiving the path information of the packet forwarding path. This is not specifically limited.

406: The network device determines a business relationship of the first AS pair and a business relationship of the second AS pair.

It may be understood that the database includes at least two types of business relationships. Because there is a mapping relationship between an AS pair and a business relationship, the business relationship of the first AS pair and the business relationship of the second AS pair are directly determined based on the database.

The network device determines, based on the business relationship of the first AS pair and the business relationship of the second AS pair, whether the packet forwarding path is valid.

A verification process in step 407 is similar to that in step 309 in FIG. 3, and

In this embodiment, because the database includes the mapping relationship between an AS pair and a business relationship, business relationships of neighboring AS pairs may be directly obtained based on the database, and a business relationship of a to-be-verified AS pair may be deduced based on a business relationship of another AS pair without one-by-one comparison and matching. The verification process is simpler, verification failures caused due to that an AS performs no registration are greatly reduced, and trustworthy of a verification result is improved.

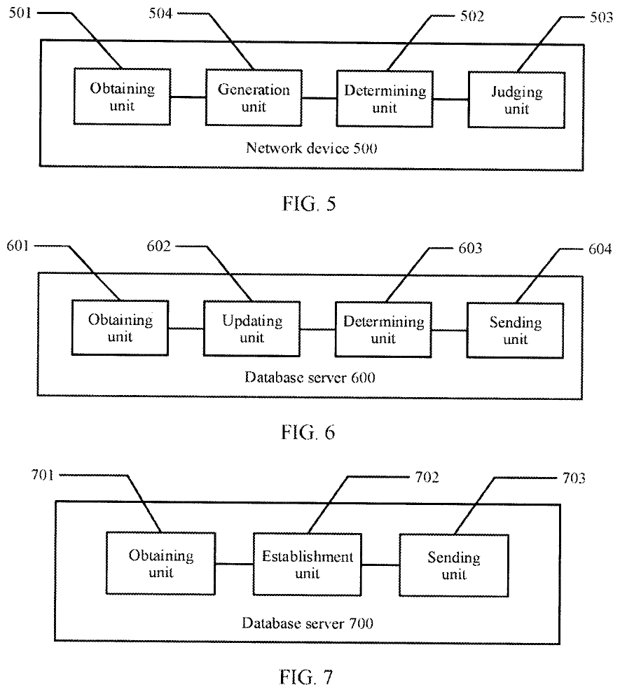

FIG. 5 is a schematic diagram of a structure of a network device 500 according to an embodiment of the present disclosure. As shown in FIG. 5, the network device 500 includes: an obtaining unit 501 configured to obtain path information of a packet forwarding path, where the packet forwarding path passes through a third AS, a second AS, and a first AS in sequence, and the third AS, the second AS, and the first AS are sequentially adjacent; a determining unit 502 configured to determine a business relationship of a first AS pair and a business relationship of a second AS pair, where the first AS pair includes the first AS and the second AS that are sequentially arranged, and the second AS pair includes the second AS and the third AS that are sequentially arranged; and a judging unit 503 configured to determine, based on the business relationship of the first AS pair and the business relationship of the second AS pair, whether the packet forwarding path is valid.

The obtaining unit 501 performs the method described in step 306 in the embodiment shown in FIG. 3 or step 404 in the embodiment shown in FIG. 4, the determining unit 502 performs the method described in step 308 in the embodiment shown in FIG. 3 or step 406 in the embodiment shown in FIG. 4, and the judging unit 503 performs the method described in step 309 in the embodiment shown in FIG. 3 or step 407 in the embodiment shown in FIG. 4.

In another embodiment of the network device 500 provided in embodiments of the present disclosure, the business relationship includes a C2P relationship, a P2C relationship, and a peering relationship.

If the business relationship of the first AS pair is the C2P relationship, an TSP corresponding to the first AS is a customer of an ISP corresponding to the second AS.

If the business relationship of the first AS pair is the P2C relationship, an ISP corresponding to the first AS is a provider of an ISP corresponding to the second AS.

If the business relationship of the first AS pair is the peering relationship, an ISP corresponding to the first AS and an ISP corresponding to the second AS are peers to each other.

In another embodiment of the network device 500 provided in embodiments of the present disclosure:

The obtaining unit 501 is configured to obtain databases, where the databases include a first database and a second database, the first database includes a first set, the first set includes at least one AS pair, and the second database includes at least one AS pair.

The determining unit 502 is further configured to: when the first set includes the first AS pair, determine that the business relationship of the first AS pair is the C2P relationship; or when the first database does not include the first AS pair, but the second database includes the first AS pair, determine that the business relationship of the first AS pair is the P2C relationship.

The obtaining unit 501 performs the method described in step 304 and step 305 in the embodiment shown in FIG. 3, and the determining unit 502 performs the method described in step 308 in the embodiment shown in FIG. 3.

In another embodiment of the network device 500 provided in embodiments of the present disclosure, the first database further includes a second set, and the second set includes at least one AS pair.

The determining unit 502 is further configured to: when the second set includes the first AS pair, determine that the business relationship of the first AS pair is the peering relationship.

The determining unit 502 performs the method described in step 308 in the embodiment shown in FIG. 3.

In another embodiment of the network device 500 provided in embodiments of the present disclosure, the third AS is the 1^{st} AS that the packet forwarding path passes through.

In another embodiment of the network device 500 provided in embodiments of the present disclosure, the packet forwarding path passes through a plurality of ASes in sequence, the path information of the packet forwarding path includes an ordered AS identifier list, the ordered AS identifier list includes a plurality of sequentially arranged AS identifiers, and the plurality of AS identifiers are mapped one-to-one to the plurality of ASes.

In another embodiment of the network device 500 provided in embodiments of the present disclosure, the network device further includes a generation unit 504, and the obtaining unit 501 is further configured to download the first database from a database server.

The generation unit 504 is configured to generate the second database based on the first database.

The generation unit 504 performs the method described in step 305 in the embodiment shown in FIG. 3, and the obtaining unit 501 performs the method described in step 304 in the embodiment shown in FIG. 3.

In another embodiment of the network device 500 provided in embodiments of the present disclosure, the obtaining unit 501 is further configured to obtain a database, where the database includes a mapping relationship between the first AS pair and a first business relationship and a mapping relationship between the second AS pair and a second business relationship.

The determining unit 502 is further configured to determine that the business relationship of the first AS pair is the first business relationship, and determine that the business relationship of the second AS pair is the second business relationship.

The obtaining unit 501 performs the method described in step 403 in the embodiment shown in FIG. 4, and the determining unit 502 performs the method described in step 406 in the embodiment shown in FIG. 4.

In another embodiment of the network device 500 provided in embodiments of the present disclosure, the obtaining unit 501 is further configured to download the database from a database server.

The obtaining unit 501 performs the method described in step 403 in the embodiment shown in FIG. 4.

FIG. 6 is a schematic diagram of a structure of a database server 600 according to an embodiment of the present disclosure. As shown in FIG. 6, the database server 600 includes: an obtaining unit 601 configured to obtain registration information, where the registration information includes a first AS identifier pair and a business relationship of the first AS identifier pair, and the first AS identifier pair includes a first AS identifier and a second AS identifier that are sequentially arranged; and an updating unit 602 configured to update a database based on the registration information, where the updated database includes a mapping relationship between the first AS identifier pair and the business relationship of the first AS identifier pair.

The obtaining unit 601 performs the method described in step 401 in the embodiment shown in FIG. 4, and the updating unit 602 performs the method described in step 402 in the embodiment shown in FIG. 4.

In another embodiment of the database server 600 provided in embodiments of the present disclosure, information about the business relationship of the first AS identifier pair is a C2P relationship, a peering relationship, or a P2C relationship.

If the business relationship of the first AS identifier pair is the C2P relationship, an ISP corresponding to a first AS is a customer of an ISP corresponding to a second AS.

If the business relationship of the first AS identifier pair is the P2C relationship, an ISP corresponding to a first AS is a provider of an ISP corresponding to a second AS.

If the business relationship of the first AS identifier pair is the peering relationship, an ISP corresponding to a first AS and an ISP corresponding to a second AS are peers to each other.

In another embodiment of the database server 600 provided in embodiments of the present disclosure, the updated database further includes a mapping relationship between a second AS identifier pair and a business relationship of the second AS identifier pair, and the second AS identifier pair includes the second AS identifier and the first AS identifier that are sequentially arranged.

The server further includes a determining unit 603, where the determining unit 603 is configured to: determine that the business relationship of the first AS identifier pair is the same as the business relationship of the second AS identifier pair; and determine that the mapping relationship between the first AS identifier pair and the business relationship of the first AS identifier pair is abnormal, and determine that the mapping relationship between the second AS identifier pair and the business relationship of the second AS identifier pair is abnormal.

The determining unit 603 performs the method described in step 402 in the embodiment shown in FIG. 4.

In another embodiment of the database server 600 provided in embodiments of the present disclosure, the database server further includes a sending unit 604, where the sending unit 604 is configured to send the mapping relationship between the first AS identifier pair and the business relationship of the first AS identifier pair to a network device based on the updated database.

The sending unit 604 performs the method described in step 403 in the embodiment shown in FIG. 4.

FIG. 7 is a schematic diagram of a structure of a database server 700 according to an embodiment of the present disclosure. As shown in FIG. 7, the database server 700 includes: an obtaining unit 701 configured to obtain registration information, where the registration information includes a first AS identifier pair, and the first AS identifier pair includes a first AS identifier and a second AS identifier that are sequentially arranged; and an establishment unit 702 configured to: establish a first database based on the registration information, where the first database includes the first AS identifier pair; and establish a second database, where the second database includes a second AS identifier pair, and the second AS identifier pair includes the second AS identifier and the first AS identifier that are sequentially arranged.

The obtaining unit 701 performs the method described in step 301 in the embodiment shown in FIG. 3, and the establishment unit 702 performs the method described in step 302 and step 303 in the embodiment shown in FIG. 3.

In another embodiment of the database server 700 provided in embodiments of the present disclosure, a business relationship of an AS identifier pair included in the first database is a C2P relationship and/or a peering relationship, and a business relationship of an AS identifier pair included in the second database is a P2C relationship and/or the peering relationship.

In another embodiment of the database server 700 provided in embodiments of the present disclosure, the server 700 further includes a sending unit 703 configured to send the first AS identifier pair to a network device based on the first database, and send the second AS identifier pair to the network device based on the second database.

The sending unit 703 performs the method described in step 304 in the embodiment shown in FIG. 3.

FIG. 8 is a schematic diagram of a structure of another network device 800 according to an embodiment of the present disclosure. The network device 800 includes a processor 801, a memory 802, and a communication interface 803.

The processor 801, the memory 802, and the communication interface 803 are mutually connected through a bus. The bus may be a peripheral component interconnect (peripheral component interconnect, PCI for short) bus, an extended industry standard architecture (extended industry standard architecture, EISA for short) bus, or the like. The bus may be classified into an address bus, a data bus, a control bus, and the like. For ease of representation, only one bold line is used to represent the bus in FIG. 8, but this does not mean that there is only one bus or only one type of bus.

The memory 802 may include a volatile memory (volatile memory), for example, a RAM, or may include a non-volatile memory, for example, a flash memory, a hard disk drive (HDD), or a solid-state drive (SSD). Alternatively, the memory 802 may include a combination of the foregoing types of memories.

The processor 801 may be a central processing unit (CPU), a network processor (NP), or a combination of a CPU and an NP. The processor 801 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The communication interface 803 may be a wired communication interface, a wireless communication interface, or a combination thereof. The wired communication interface may be, for example, an Ethernet interface. The Ethernet interface may be an optical interface, an electrical interface, or a combination thereof. The wireless communication interface may be a wireless local area network (WLAN) interface, a cellular network communication interface, a combination thereof, or the like.

Optionally, the memory 802 may be further configured to store program instructions. The processor 801 invokes the program instructions stored in the memory 802, and may perform one or more of steps 301, 304, 305, 306, 307, 308, and 309 or steps 401, 403, 404, 405, 406, and 407 in the method embodiment shown in FIG. 3 or FIG. 4 or an optional implementation in the steps, so that the network device 800 implements a function of the network device in the foregoing methods.

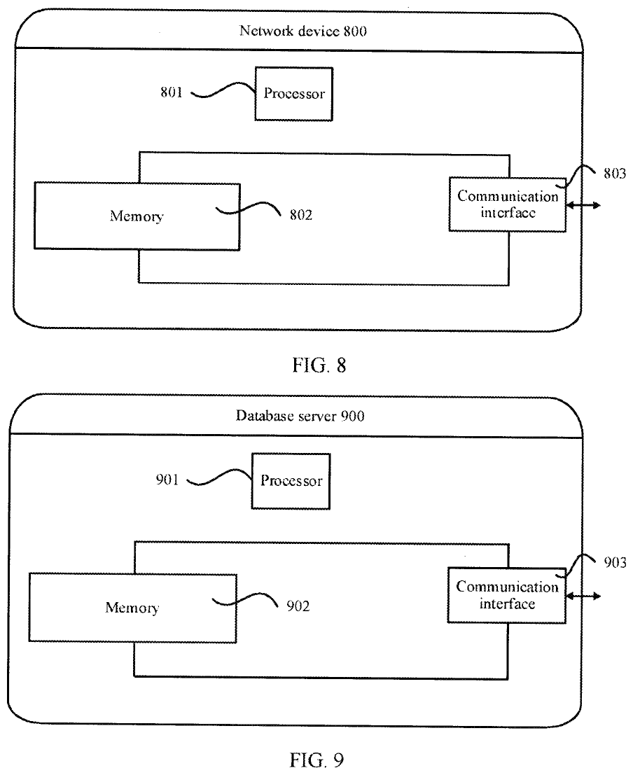

FIG. 9 is a schematic diagram of a structure of a database server 900 according to an embodiment of the present disclosure. The database server 900 includes a processor 901, a memory 902, and a communication interface 903.

The memory 902 may be used for temporary storage or permanent storage. Further, the processor 901 may be configured to communicate with the memory 902, and perform, on a sending device, a series of instruction operations in the memory 902.

In this embodiment, the processor 901 may perform operations performed by the database server in the embodiments shown in FIG. 3 and FIG. 4.

In this embodiment, specific functional module division in the processor 901 may be similar to functional module division in the receiving unit, the updating unit, and the determining unit described in FIG. 6.

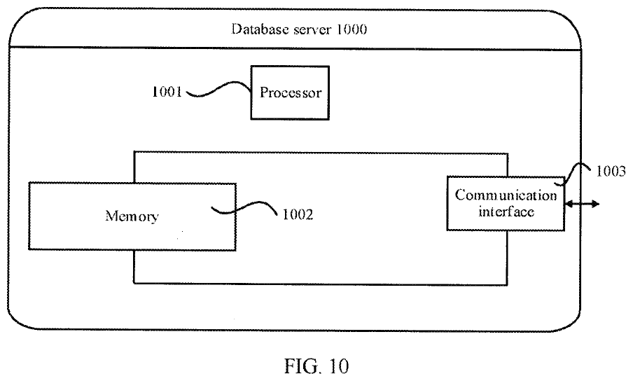

FIG. 10 is a schematic diagram of a structure of another database server 1000 according to an embodiment of the present disclosure. The database server 1000 includes a processor 1001, a memory 1002, and a communication interface 1003.

The memory 1002 may be used for temporary storage or permanent storage. Further, the central processing unit 1001 may be configured to communicate with the memory 1002, and perform, on a sending device, a series of instruction operations in the memory 1002.

In this embodiment, the central processing unit 1001 may perform operations performed by the database server in the embodiments shown in FIG. 3 and FIG. 4.

In this embodiment, specific functional module division in the central processing unit 1001 may be similar to functional module division in the receiving unit and the establishment unit described in FIG. 7.

An embodiment of the present disclosure further provides a path verification system, including the network device shown in FIG. 5 or FIG. 8, and the database server shown in FIG. 6 or FIG. 9 or the database server shown in FIG. 7 or FIG. 10.

An embodiment of the present disclosure further provides a chip or a chip system. The chip or the chip system includes at least one processor and a communication interface. The communication interface and the at least one processor are interconnected through a line, and the at least one processor runs instructions or a computer program to perform one or more steps in the method embodiment shown in FIG. 3 or FIG. 4 or an optional implementation in the steps to implement a function of the network device in the foregoing methods.

The communication interface in the chip may be an input/output interface, a pin, a circuit, or the like.

In a possible implementation, the chip or the chip system described above further includes at least one memory, and the at least one memory stores the instructions. The memory may be a storage unit inside the chip, for example, may be a register or a cache; or may be a storage unit (for example, a ROM or a RAM) of the chip.

An embodiment of the present disclosure further provides a chip or a chip system. The chip or the chip system includes at least one processor and a communication interface. The communication interface and the at least one processor are interconnected through a line. The at least one processor is configured to run a computer program or instructions, to perform the method performed by the database server according to any possible implementation in the embodiments shown in FIG. 3 and FIG. 4.

The communication interface in the chip may be an input/output interface, a pin, a circuit, or the like.

In a possible implementation, the chip or the chip system described in the present disclosure further includes at least one memory, and the at least one memory stores the instructions. The memory may be a storage unit inside the chip, for example, may be a register or a cache; or may be a storage unit (for example, a ROM or a RAM) of the chip.

An embodiment of the present disclosure further provides a computer storage medium. The computer storage medium stores computer program instructions for implementing a function of a network device in a path verification method provided in embodiments of the present disclosure.

An embodiment of the present disclosure further provides a computer storage medium. The computer storage medium stores computer program instructions for implementing a function of a database server in a database establishment method provided in embodiments of the present disclosure.

An embodiment of the present disclosure further provides a computer program product. The computer program product includes computer software instructions. The computer software instructions may be loaded by using a processor to implement a procedure in the path verification method shown in FIG. 3 or FIG. 4.

All or some of the foregoing embodiments may be implemented by using software, hardware, firmware, or any combination thereof. When software is used to implement the embodiments, all or some of the embodiments may be implemented in a form of a computer program product.

A person skilled in the art that may clearly understand that, for the purpose of convenient and brief description, for a detailed working process of the foregoing system, apparatus, and unit, refer to a corresponding process in the foregoing method embodiments.

In several embodiments provided in the present disclosure, it should be understood that the disclosed system, apparatus, and method may be implemented in other manners. For example, the described apparatus embodiments are merely examples. For example, the division into units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate parts may or may not be physically separate, and parts displayed as units may or may not be physical units, to be specific, may be located in one position, or may be distributed on a plurality of network units. Some or all of the units may be selected based on an actual requirement to achieve the objectives of the solutions of embodiments.

In addition, functional units in embodiments of the present disclosure may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially or the part contributing to some approaches, or all or some of the technical solutions may be implemented in a form of a software product. The computer software product is stored in a storage medium and includes several instructions for instructing a computer device (which may be a personal computer, a server, a network device, or the like) to perform all or some of the steps of the methods described in embodiments of the present disclosure. The foregoing storage medium includes: any medium that can store program code, such as a USB flash drive, a removable hard disk, a ROM, a RAM, a magnetic disk, or an optical disc.

What is claimed is:

1. A network device comprising:
at least one processor;
one or more memories coupled to the at least one processor and storing programming instructions, wherein the at least one processor is configured to execute the programming instructions to cause the network device to:
obtain path information of a packet forwarding path passing through a third autonomous system (AS), a second AS, and a first AS in sequence, wherein the third AS, the second AS, and the first AS are sequentially adjacent;
determine a first business relationship of a first AS pair comprising the first AS and the second AS that are sequentially arranged;
determine a second business relationship of a second AS pair comprising the second AS and the third AS that are sequentially arranged; and
determine whether the packet forwarding path is valid based on the first business relationship and the second business relationship.

2. The network device according to claim 1, wherein
when the first business relationship is a customer-to-provider (C2P) relationship, a first Internet service provider (ISP) corresponding to the first AS is a customer of a second ISP corresponding to the second AS;
when the first business relationship is a provider-to-customer relationship, the first ISP is a provider of the second ISP; and
when the first business relationship is a peering relationship, the first ISP and the second ISP are peers.

3. The network device according to claim 2, wherein the programming instructions when executed by the processor further cause the network device to:
obtain databases comprising a first database and a second database, the first database comprises a first set comprising at least one AS pair, and the second database comprises at least one AS pair; and
when the first set comprises the first AS pair, determine that the first business relationship is the C2P relationship; and
when the first database does not comprise the first AS pair and the second database comprises the first AS pair, determine that the first business relationship is the P2C relationship.

4. The network device according to claim 3, wherein the first database further comprises a second set comprising at least one AS pair; and
when the second set comprises the first AS pair, determine that the first business relationship is the peering relationship.

5. The network device according to claim 1, wherein the third AS is an initial AS of the packet forwarding path.

6. The network device according to claim 5, wherein the packet forwarding path passes through a plurality of ASes in sequence, and wherein the path information comprises an ordered AS identifier list comprising a plurality of sequentially arranged AS identifiers mapping one-to-one to the plurality of ASes.

7. The network device according to claim 4, wherein the programming instructions when executed by the processor further cause the network device to:
download the first database from a database server; and
generate the second database based on the first database.

S. The network device according to claim 1, wherein the programming instructions when executed by the processor further cause the network device to:
obtain a database comprising a first mapping relationship between the first AS pair and a third business relationship and a second mapping relationship between the second AS pair and a fourth business relationship;
determine that the first business relationship is the third business relationship based on the first mapping relationship; and
determine that the second business relationship is the fourth business relationship based on the second mapping relationship.

9. The network device according to claim 8, wherein the programming instructions when executed by the processor further cause the network device to:
download the database from a database server.

10. A database server comprising:
at least one processor;
one or more memories coupled to the at least one processor and storing programming instructions, wherein the at least one processor is configured to execute the programming instructions to cause the database server to:
obtain registration information comprising a first autonomous system (AS) identifier pair and a business relationship of the first AS identifier pair, and the first AS identifier pair comprises a first AS identifier and a second AS identifier that are sequentially arranged; and
update a database based on the registration information, wherein the updated database comprises a mapping relationship between the first AS identifier pair and the business relationship.

11. The database server according to claim 10, wherein the programming instructions when executed by the processor further cause the database server to:
send the mapping relationship to a network device based on the updated database.

12. A path verification system, comprising a network device and a database server,
wherein the database server is configured to:
obtain registration information comprising a first autonomous system (AS) identifier pair and a business relationship of the first AS identifier pair, and the first AS identifier pair comprises a first AS identifier and a second AS identifier that are sequentially arranged; and
update a database based on the registration information, wherein the updated database comprises a mapping relationship between the first AS identifier pair and the business relationship;
the network device is configured to:
obtain path information of a packet forwarding path passing through a third AS, the second AS, and the first AS in sequence, and the third AS, the second AS, and the first AS are sequentially adjacent;
determine a first business relationship of a first AS pair and a second business relationship of a second AS pair, wherein the first AS pair comprises the first AS and the second AS that are sequentially arranged, and the second AS pair comprises the second AS and the third AS that are sequentially arranged; and
determine whether the packet forwarding path is valid based on the first business relationship and the second business relationship.

13. The path verification system according to claim 12, wherein
when the first business relationship is a customer-to-provider (C2P) relationship, a first Internet service provider ISP corresponding to the first AS is a customer of a second ISP corresponding to the second AS;
when the first business relationship is a provider-to-customer (P2C) relationship, the first ISP corresponding is a provider of the second ISP; and
when the first business relationship is a peering relationship, the first ISP and the second ISP are peers.

14. The path verification system according to claim 13, wherein network device is further configured to:
obtain databases comprising a first database and a second database, the first database comprises a first set comprising at least one AS pair, and the second database comprises at least one AS pair; and
when the first set comprises the first AS pair, determining, by the network device, that the first business relationship is the C2P relationship; and
when the first database does not comprise the first AS pair and the second database comprises the first AS pair, determining, by the network device, that the first business relationship is the P2C relationship.

15. The path verification system according to claim 14, wherein the first database further comprises a second set comprising at least one AS pair; and
when the second set comprises the first AS pair, determine that the first business relationship is the peering relationship.

16. The path verification system according to claim 14, wherein the third AS is an initial AS of the packet forwarding path.

17. The path verification system according to claim 16, wherein the packet forwarding path passes through a plurality of ASes in sequence, and wherein the path information comprises an ordered AS identifier list comprising a plurality of sequentially arranged AS identifiers mapping one-to-one to the plurality of ASes.

18. The path verification system according to claim 16, wherein the network device is further configured to:
download the first database from a database server; and
generate the second database based on the first database.

19. The path verification system according to claim 12, wherein the network device is further configured to:
obtain a database comprising a first mapping relationship between the first AS pair and a third business relationship and a second mapping relationship between the second AS pair and a fourth business relationship;
determine that the first business relationship is the third business relationship based on the first mapping relationship; and
determine that the second business relationship is the fourth business relationship based on the second mapping relationship.

20. The path verification system according to claim 19, wherein network device is further configured to:
download the database from a database server.
